(19) United States
(12) Patent Application Publication
(10) Pub. No.: US 2007/0227977 A1
(43) Pub. Date: Oct. 4, 2007

(54) Method and device to remediate oil spill

(75) Inventors: Bandar A. Fadhel, Dammam (SA); Jasem M. Al-Muaili, Dhahran (SA); Tamal Kanti Dutta, Dhahran (SA); Emad Y. Al-Humaidan, Dammam (SA); Mariam H. Al-Soufi, Dammam (SA); Abdulrahman M. Mukhtar, Dhahran (SA)

Correspondence Address: ABELMAN, FRAYNE & SCHWAB, 666 THIRD AVENUE, 10TH FLOOR, NEW YORK, NY, 10017, US

(73) Assignee: Saudi Arabian Oil Company

(21) Appl. No.: 11/395,449

(22) Filed: Mar. 30, 2006

(51) Int. Cl. C02F 1/28

(52) U.S. Cl. 210/693; 210/924

(57) ABSTRACT

Irregularly shaped particles of foamed cellular polystyrene having a relatively large surface area produced by comminuting preformed solid blocks or other shapes of molded expanded polystyrene foam articles are spread on floating marine oil spills to agglomerate the oil and maintain it on the surface pending removal, thereby avoiding contamination of the submarine environment. The particles can be distributed in a dry state or mixed with a liquid to facilitate controlled spreading of the lightweight particles.

### FIELD OF THE INVENTION

This invention relates to a prepared product and method for agglomerating and removing oil that has been spilled in the marine environment, including crude oil, bunker oil and other heavy oil products.

### BACKGROUND OF THE INVENTION

The catastrophic effects on the environment of marine oil spills are well known. A principal problem is the eventual loss of buoyancy or increase in specific gravity of the spilled oil that leads to the sinking of clumps of oil for which there is no practical means of recovery from the submarine environment.

Various physical and chemical means have been proposed and are in use for ameliorating and recovering oil spills. Most of the means known to the prior art have limited capabilities to effectuate the complete recovery or clean-up of oil-spills, particularly those occurring at sea. Whether effective or not, means employed to date have been expensive.

It is therefore an object of the present invention to provide a novel product and method that is relatively inexpensive to produce and relatively easy to deploy at the site of the spill.

Another object of the invention is to provide a product that can be produced using polymeric packing materials and other waste that would customarily be consigned to land fills or other disposal sites.

Yet another object of the invention is to provide a product and method for its use that will maintain the spilled oil on the surface of the body of water and prevent the oil from sinking into the submarine environment before it can be recovered.

### SUMMARY OF THE INVENTION

The above objects and additional advantages are achieved by the present invention in which oil-absorbent particles are prepared by grinding, abrading, shredding, pulverizing or otherwise comminuting preformed and molded blocks or other relatively larger regular or irregular pieces of rigid foamed or expanded cellular polystyrene into particles possessing a cellular structure and having irregular shapes and large oil-contacting surface area. In one preferred embodiment of the invention, the particle size distribution is in the range of from 4 mesh to 16 mesh, based on a corresponding aperture size from 4.75 mm to 1.18 mm.

The particles are spread on the surface of the oil spill and the water surrounding the margins of the spill. As compared to the density of water at one gram/cc and oil (average density of about 0.8 gm/cc), the foamed polystyrene with a density of 0.02 gm/cc is capable of maintaining its position on the surface even after absorbing water and/or oil. The foamed or expanded cellular polystyrene particles that are placed on the surface of the oil or that otherwise float into contact with the spilled oil, agglomerate and maintain the oil on the surface of the water, thereby facilitating removal of the spilled oil from the water's surface and also preventing it from eventually sinking below the surface where it can cause further damage to the marine environment.

The particles can be most economically produced by using disposable molded polystyrene foamed packaging materials, insulating panels and other waste materials having a rectilinear or other regular configuration. Irregular shapes and sizes of expanded foamed polystyrene materials can also be used. Waste or scrap material from facilities producing molded foamed polystyrene products can also be used for further processing. The material is commonly referred to by its trademark STYROFOAM which is registered in the United States and elsewhere. The invention has the further desirable environmental effect of reducing the quantity of such materials that are currently disposed of in land fills and waste disposal sites, or by less desirable means.

Particles of the appropriate size have been produced by contacting preformed molded packaging materials of a variety of shapes with an abrasive surface in the form of a conventional abrasive, such as emery/corundum cloth and sandpaper. Any of a wide variety of other abrasive surfaces and devices known to the art can also be used to comminute the cellular polystyrene foam starting material. Shredding machines, pulverizing devices and other material handling and treating equipment known to the art can be used, or adapted for use, in preparing the particles in the size ranges desired for use in the invention. Expanded polystyrene foam particles that have been produced directly from expandable beads and not molded into shapes can also be used directly. Particles having an irregular surface and concomitant large surface area are preferred for use in the invention.

As will be apparent to those of ordinary skill in the art, specialized apparatus can be constructed for comminuting large volumes of scrap foam waste products for use in the invention. For example, foamed polystyrene material recovered from recycling centers can be supplied to an automated processing facility that includes a feed hopper, a conveyor for the foamed material, a primary shredder to reduce the size of larger pieces to a predetermined maximum, and one or more comminuting rollers that draw the foamed material through opposing surfaces to produce particles in the desired size range. Industrial shredding, chipping and milling machines can also be used or adapted for use in producing the particles having the desired size and irregular surfaces for the practice of the invention.

Scraps and pieces of waste foamed polystyrene have been comminuted in a blender to produce a satisfactory mix of particles for sieving and testing. Care must be taken to avoid excessive heating during this operation, since the foamed particles are subject to melting.

### DETAILED DESCRIPTION OF PREFERRED EMBODIMENTS

In the following series of tests, blocks of molded foamed polystyrene packing material were abraded using a medium grade of emery cloth. The resulting particles were collected and sieved using laboratory sieve screens acquired from W.S. Tyler, Inc. The operative sizes corresponding to the mesh numbers for the laboratory sieve screens used are set forth in Table 1.

TABLE 1

| | Mesh # | | | | |
|---|---|---|---|---|---|
| | 4 | 8 | 12 | 14 | 16 |
| Aperture (mm) | 4.75 | 2.36 | 1.70 | 1.40 | 1.18 |

The irregular expanded foam polystyrene particles collected during the abrading process were introduced in a sieve tower that included 4, 8, 12, 14 and 16 mesh sieves or screens. The tower was agitated and the particles were collected from below each sieve for testing.

A series of tests were conducted on samples of Arab light crude oil using predetermined quantities of the ground foamed polystyrene particles collected during the sieving step described above. Particles of 4, 8, 12 and 16 mesh size were tested. The data of Table 2 reports the absorption efficiency of each of the particle sizes when the same total weight of each particle size was manually spread over the surface of oil floating on water in laboratory glassware. Test were conducted using fresh water and seawater with comparable results.

In these tests, three (3) grams of particles of the indicated mesh size were spread on 30 ml. of light crude oil on water in a 250 ml. glass beaker and lightly stirred using a glass rod. The test sample was removed from the water's surface using a hand-held sieve. The efficiency results reported in Table 2 are the average of three sample tests for each of the mesh sizes.

The absorption efficiency recorded in Table 2 was calculated as follow:

$$Efficiency = [ \frac{\begin{matrix}( Foam Final Weight - Foam Initial Weight ) - \\ Weight of Absorbed Water\end{matrix}}{Crude Oil Weight} ] \times 100$$

The weight of water absorbed by a 3 g foam sample was determined to average 2.15 g.

TABLE 2

| | | | | Foam | Foam | | |
|---|---|---|---|---|---|---|---|
| | | Crude | Crude | Initial | Final | Absorption | |
| Exp | Mesh | volume | weight | Weight | Weight | Efficiency | Avg. |
| # | Size | (ml) | (g) | (g) | (g) | (%) | (%) |
| 1 | 16 | 30.00 | 25.60 | 3.00 | 29.00 | 93.16 | 95 |
| 2 | | 30.00 | 25.60 | 3.00 | 29.70 | 95.90 | |
| 3 | | 30.00 | 25.70 | 3.00 | 29.50 | 94.75 | |
| 1 | 12 | 30.00 | 25.50 | 3.00 | 29.70 | 96.27 | 99 |
| 2 | | 30.00 | 25.50 | 3.00 | 30.70 | 100.20* | |
| 3 | | 30.00 | 25.50 | 3.00 | 30.70 | 100.20* | |
| 1 | 8 | 30.00 | 25.80 | 3.00 | 27.70 | 87.40 | 95 |
| 2 | | 30.00 | 25.90 | 3.00 | 29.70 | 94.79 | |
| 3 | | 30.00 | 25.90 | 3.00 | 31.70 | 102.51* | |
| 1 | 4 | 30.00 | 25.60 | 3.00 | 50.00 | 81.45 | 78 |
| 2 | | 30.00 | 25.60 | 3.00 | 50.00 | 81.45 | |
| 3 | | 30.00 | 25.60 | 3.00 | 47.00 | 69.73 | |

Efficiency values in Table 2 that exceed 100% are marked with an asterisk (*) and are due to the presence of water droplets that were entrained in oil-containing foam particle clusters. When the particles form into clusters, small cavities are created in which water droplets can be entrained. Droplets are also transferred during the sieving step. To the extent that the droplets were observed, they were dried out or decanted from the weighing dish before the measurement was taken. In any event, the trend in the data collected establishes the utility of the product and its method of use in stabilizing oil spills for removal.

The results of these tests indicate that the smaller particles are capable of absorbing a relatively greater quantity of light crude oil for a given weight of the foamed cellular polystyrene particles.

In another series of tests, the rate of water absorption of test particles of foamed polystyrene was determined. Particles passing the 8 mesh screen were collected and equal quantities weighting 1.06 grams were placed in water for time periods of ten minutes and twenty minutes, respectively, removed and weighed to determine the weight of water absorbed.

Other groups of particles were placed for periods of 10 and 20 minutes, respectively, on the surface of 10 ml of light crude oil that was floating on water contained in a 250 ml glass beaker. The particles were then removed for weighing. The results, as reported in Table 3, indicate that one gram of 8 mesh foam absorbs on average about 1.57 gm of water in each of the two time intervals, and with no significant observable effect on the efficiency of oil adsorption.

TABLE 3

| Sample # (Time) | Water Absorbed (gm) | Oil Absorbed (gm) |
|---|---|---|
| 1 (10 min.) | 1.44 | 6.23 |
| 2 (10 min.) | 1.54 | 6.24 |
| 3 (10 min.) | 1.64 | 6.05 |
| 4 (20 min.) | 1.72 | 6.02 |
| 5 (20 min.) | 1.72 | 6.08 |
| 6 (20 min.) | 1.34 | 6.40 |

This aspect of the product is important in the practice of the invention where the foam particles can be expected to come into contact with water surrounding the spill or in channels or openings formed between portions of the spilled oil caused by wind, waves and/or the irregular leakage of oil from the source of the spill. Thus, even though the foamed particles of the invention come into contact with water, they retain their capacity to absorb and agglomerate the oil with almost the same efficiency as particles contacting only the oil.

Without being limited to a particular theory, this advantageous effect may be related to the surface tension, measured in dynes/cm², of the components of the system. With a value of 73 the surface tension of water is much greater than that of oil at 35 and foamed polystyrene at 33. The relatively small difference in the surface tension of the oil and polystyrene apparently facilitates their ready “mixing” and agglomeration.

It has also been found that the foamed particles maintain their integrity and are not degraded by relatively long contact with the agglomerated oil. In one extended test, the particles spread on the oil maintained the oil on the surface of water for about six months. As would be expected, no apparent degradation in foamed polystyrene particles left in water without oil has been observed in similar long-term tests.

Preparation of Foam Particles

Rigid polystyrene foam, or expanded cellular polystyrene, can be produced from expandable cellular polystyrene beads or purchased in the form of blocks, panels, sheets and other custom shapes. In a preferred embodiment of the present invention, foamed packaging materials such as those used for packaging and cushioning a wide variety of products, including electronic devices and other delicate equipment are collected as a waste product. These waste materials are contacted with a grinding or abrading surface, such as emery cloth, sandpaper and the like.

The ground particles of foamed polystyrene can be dispersed on, and around the surface of the marine oil spill by any convenient means that is available. Because of its low density, the particulate foamed polystyrene of the invention can be packaged for manual handling in relatively large and light-weight containers, such as disposable plastic bags. The plastic bags can be carried to the scene of the spill by aircraft, e.g., helicopters, and small boats, where the bags are cut open for dispersal of the particles.

The particles can also be dispersed by compressed air and/or pressurized air jets using large diameter hoses, tubes and nozzles. Under appropriate weather conditions, dispersal points can be selected upwind of the spill and the effect of prevailing winds utilized to assist in distributing the light-weight particles over the surface of the spill. Small watercraft can navigate the clear periphery of the spill where the crew can manually disperse the particles onto the water adjacent the spill to define a boundary for later collection of agglomerated particles. The dispersal of the particles can also be used with floating booms of the type used to contain marine spills that will also serve to contain the floating particles of the invention for eventual pick-up.

Specialized equipment currently available for distributing lightweight materials of other types can also be adapted for use in this aspect of the method of the invention. In one embodiment, the foamed polystyrene particles are sprayed as a slurry with water and/or other chemicals to permit their wider dispersal from the periphery towards the center of an expansive spill.

Aircraft equipped with bins or hoppers for containing the particles and having associated screw feeds or other means for the controlled volumetric discharge of the particles from dispensing tubes or nozzles projecting from the aircraft can be used advantageously to disperse the particles in areas that might not otherwise be accessed and/or reached quickly by water craft or land-based personnel and equipment. The particles can also be air-dispersed from large, light-weight containers of the type used to drop water in fighting forest fires. The particles can be wetted with water and/or other chemicals to increase their density to a predetermined, controlled value to facilitate their controlled dispersal.

A chemical emulsifier can also be sprayed or otherwise applied to the surface of the oil spill in conjunction with the dispersal of the expanded foam polystyrene to enhance the agglomeration of the materials.

Chemical wetting agents can also be applied to the particles prior to, or at the time of their dispersal to facilitate agglomeration after they have contacted the surface of the oil. The wetting agent is selected to further reduce the surface tension of the particle-oil interface.

While several illustrative embodiments have been provided for the preparation of the particles and their methods of use, other means will be apparent from this disclosure to those of ordinary skill in the art.

We claim:

1. A prepared product for agglomerating and maintaining oil on the surface of a body of water to facilitate its removal and to minimize damage to the submarine environment, the product comprising irregularly shaped particles of expanded cellular foamed polystyrene having an irregular surface.

2. The product of claim 1, wherein the irregularly shaped particles pass through 4 mesh to 16 mesh sieve screens having corresponding apertures in the range of 4.15 mm to 1.18 mm, respectively.

3. The product of claim 1, wherein the irregular surfaces of the particles provide an oil-contacting surface area that is substantially greater than the surface area of an expanded foamed polystyrene particle passing the same mesh and having a smooth untreated surface.

4. The product of claim 1 that is produced by grinding, abrading, comminuting, pulverizing or shredding a preformed molded article formed of cellular expanded foamed polystyrene.

5. The product of claim 4 that is produced by contacting the preformed molded article with an abrasive surface.

6. The product of claim 1 that includes a chemical additive to enhance the oil absorbency of the particle in the marine environment.

7. The product of claim 6 in which the chemical additive is incorporated in the expandable polystyrene composition at the time of its manufacture.

8. The product of claim 6, wherein the particles are impregnated with the chemical additive.

9. The product of claim 8 in which the chemical additive is applied in the form of a liquid solution to the particles.

10. The product of claim 1 which includes an anti-static agent.

11. The product of claim 10 in which the anti-static agent is incorporated in the expandable polystyrene composition.

12. A method of ameliorating the adverse effects of a marine oil spill by maintaining the spilled oil on the surface of a body of water to facilitate removal of the oil and to minimize damage to the submarine environment, the method comprising spreading an efficacious amount of oil-absorbing particles of foamed expanded cellular polystyrene over the surface of the spilled oil on the body of water, whereby the oil is absorbed by, and agglomerates the particles to thereby maintain the oil on the water's surface for recovery.

13. The method of claim 12 which includes spreading foamed cellular polystyrene particles on the surface of oil-free water at the margins of the spilled oil.

14. The method of claim 12, wherein the foamed polystyrene particles are of an irregular configuration.

15. The method of claim 12, wherein the foamed polystyrene particles have an irregular surface, whereby the oil-contacting surface area is substantially greater than particle of comparable dimensions having a smooth surface.

16. The method of claim 12, wherein the particles of foamed polystyrene are prepared by grinding, abrading, comminuting, pulverizing or shredding a preformed molded article produced from expandable polystyrene beads.

17. The method of claim 16, wherein the foamed polystyrene particles are produced by contacting the preformed molded article with an abrasive surface.

18. The method of claim 12, which further includes applying a liquid emulsifier solution to the oil spill.

19. The method of claim 12, wherein the foamed polystyrene particles are spread by discharging the dry particles from a nozzle under the force of a pressurized fluid stream.

20. The method of claim 12, wherein the particles of foamed polystyrene are spread by discharging the particles from an aircraft located above the oil spill.

21. The method of claim 12 which includes the further step of mixing the particles with a liquid, wherein the particles of foamed polystyrene are spread by discharging the particles with the pressurized liquid sprayed from a nozzle.

22. The method of claim 21, wherein the liquid includes at least one chemical additive for treating the oil spill.

23. The method of claim 22, wherein the chemical additive enhances the agglomeration of the oil and the foamed polystyrene particles.

24. A product comprising a buoyant agglomerated mixture of oil and particles of expanded foamed polystyrene recovered from a marine environment.
